(19) United States
(12) Patent Application Publication
(10) Pub. No.: US 2016/0348416 A1
(43) Pub. Date: Dec. 1, 2016

(54) FAN-SHAPED PEDESTRIAN BARRIER

(71) Applicants: Vittorio CURCI, Bisceglie (BA) (IT); PH-15 S.R.L., Bisceglie (BA) (IT)

(72) Inventor: Vittorio CURCI, Bisceglie (BA) (IT)

(21) Appl. No.: 15/116,665

(22) PCT Filed: Jan. 30, 2015
(86) PCT No.: PCT/IB2015/000098

§ 371 Date: Aug. 4, 2016

(30) Foreign Application Priority Data
Feb. 4, 2014 (IT) BA2014A000006

(51) Int. Cl. E05F 15/47; E06B 5/10; E05F 15/605; E05F 15/70; E05F 15/53; E05F 15/51; E05F 15/49; E06B 9/00

(52) U.S. Cl. CPC E05F 15/47; E05F 15/49; E06B 5/10; E06B 9/00; E05F 15/70; E05F 15/53; E05F 15/51; E05F 15/605; E06B 2009/002

(57) ABSTRACT

Retractable floor barriers are provided that can be quickly opened and closed by pneumatic actuators and operated by the closing and opening of an electrical circuit. The retractable floor barriers can be used at the docks of trains and subway stations to prevent accidental falls therefrom.

The current state of art does not disclose the existence of pedestrian barriers of the type object of the present invention.

Retractable traffic barriers exist in a cylindrical shape or chain (bound to two external columns and sliding in the vertical direction) no type of barriers exist that involve the use of fans in micro-perforated sheet of PVC concealed in the floor.

The aim of the present invention described in the following, is that to resolve the problem of the accidental fall from the docks of trains and subway stations through the creation of floor retractable barriers, quickly opened and closed by means of pneumatic actuators and operated by the closing and opening of an electrical circuit.

With the open circuit the pedestrian barriers are in the open position in this way inhibiting the access to the tracks and accidental falls from the docks; with the arrival of the train in station, in correspondence of a stroke end, this (now stopped) mechanically closes the circuit instantaneously bringing the barriers in the floor in the retractable closure position and in this way allowing the transit of the passengers. At the restart of the train the same initial state of the pedestrian barrier is re-established.

The application of the pedestrian barriers object of the invention could be extended to the demarcation of areas closed the public, for example, in fair stands, the delimitation of walking areas during works, etc. In case of temporary applications the solution of metal casing not enclosed but positioned and blocked on the same floor by suitable means.

The pedestrian barrier according to the present invention is illustrated in a preferred embodiment by the figures and drawings attached that respectively illustrate:

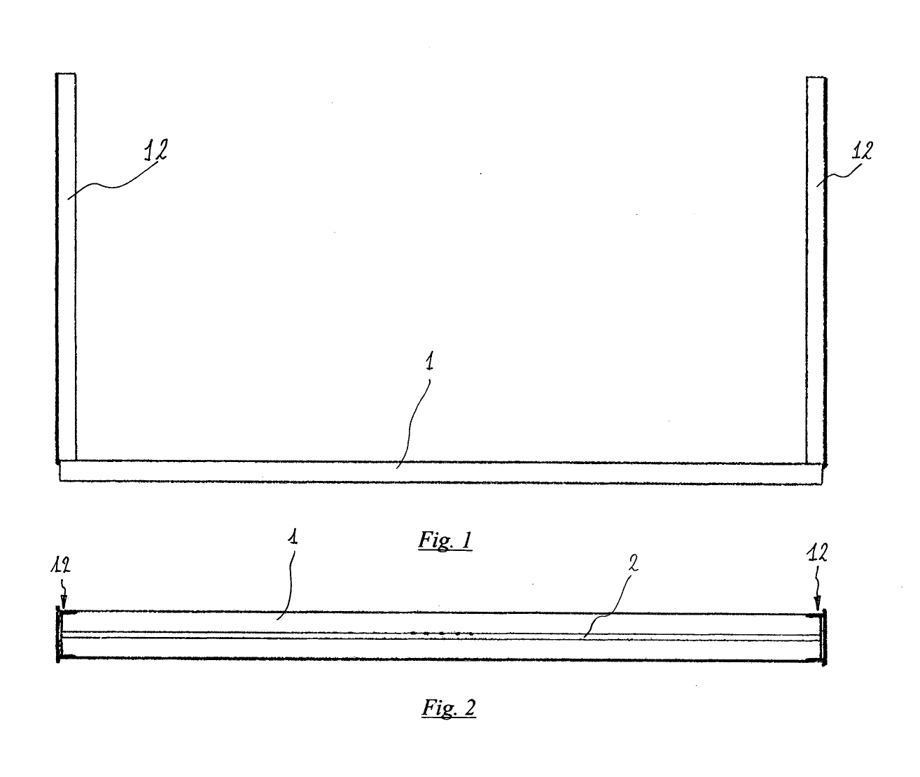

FIG. 1—a front view of the metal casing in the opened position;

FIG. 2—a top view of the metal casing in the closed position;

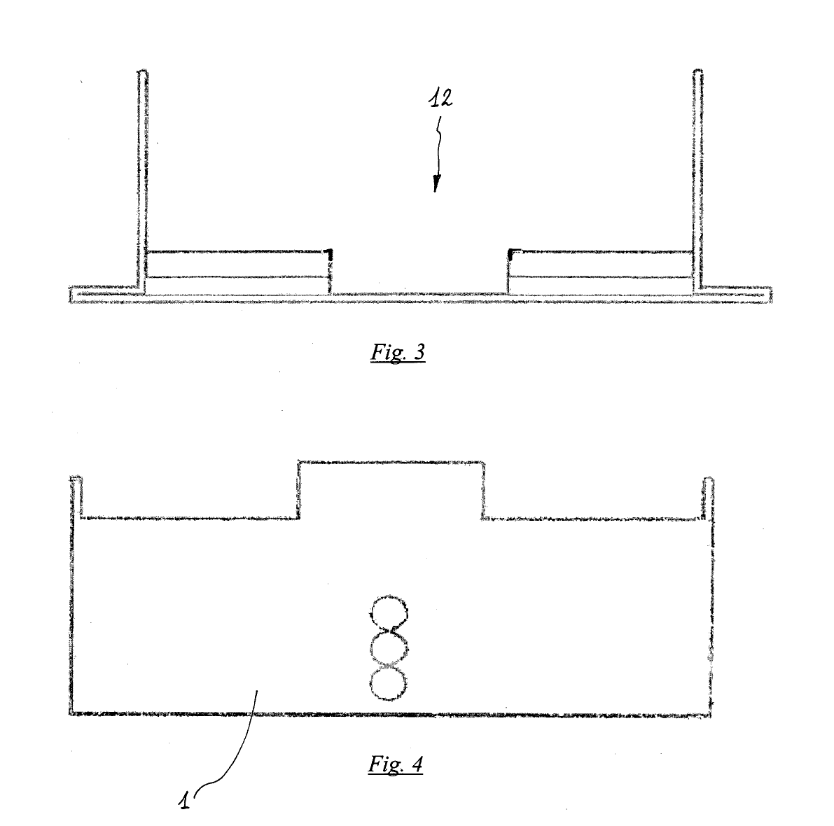

FIG. 3—a cross-view of the metal casing cover;

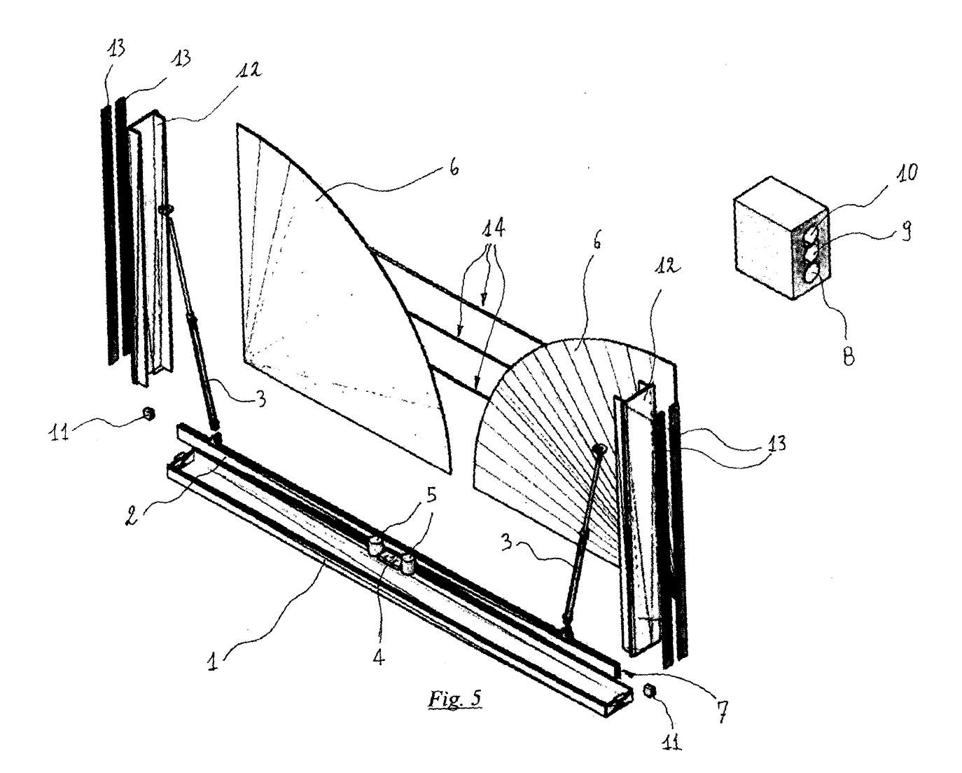

FIG. 4—a cross-view of the metal casing;

FIG. 5—exploded view of the fan-shaped pedestrian barrier;

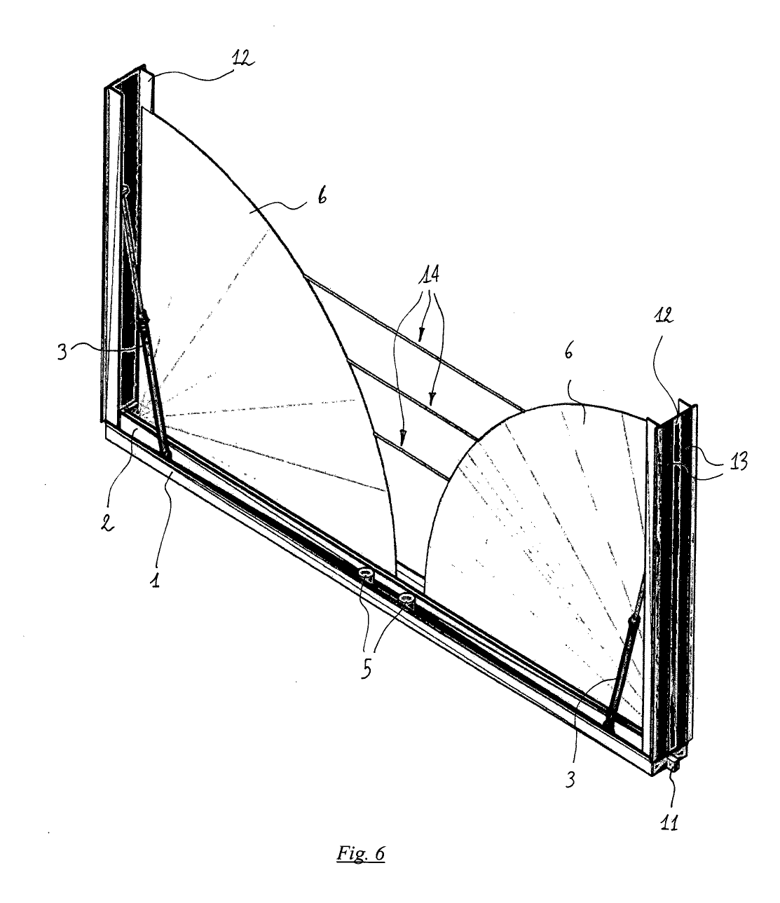

FIG. 6—assembled 3D view of the fan-shaped pedestrian barrier.

The single module of the pedestrian fan barrier is made of a metal casing 1 15/10 (sheet thickness referred to a mere application example susceptible of variations) of 143.2×2353×56.5 dimensions in mm (D×W×H: dimensions refer to a mere application example subject to change)

This casing is divided into two symmetrical longitudinal areas: in one area two base brackets 2 of the pneumatic actuators 3 are positioned, the electropneumatic valve 4 for actuating the pneumatic actuators 3 in a central position and two electromagnetic catches 5, in said area the actuators 3 are placed in a closing position of the barrier. In the other area the fans in PVC micro-perforated sheet 6 are positioned.

The two areas are dived by a “U” shaped metal sheet profile 15/10 (sheet thickness refers to a mere application example susceptible of variations) inside of which run parallel, one on the other, the three pipelines and, precisely, starting from the bottom, the pipeline of compressed air piping 8 connected to the electropneumatic valve 4 serving the two actuators 3, the electric pipeline 9 connected to the same valve 4 and the electric pipeline 10 connected to the two electromagnetic catches 5: at the upstream and downstream of this element there are serial connectors 11 for the connection in series of more barriers (for example along a railway platform)

The fans of PVC 6 are made of perforated sheet so as to reduce the action of the wind, one end is integral and connected to the metal casing 1, the other end to the metal case cover 12 always realized in 15/10 sheet (thickness refers to a mere application example susceptible of variations), each of the two casings is hinged to the metal case.

The actuators in the process of opening and closing move the crankcase determining the closure and opening of the fans in PVC. The crankcase in the closure position fits perfectly in the case enclosed on the floor and their covering surface is coplanar with the walking floor surface.

The two electromagnetic catches 5 are used to tighten the closure of the case cover 12. On the walking floor surface the crankcase area two longitudinal thin layers in reflective and non slip material 13 are applied.

The two fans in the open position are held in tension by means of three elastic straps 14 which have the function to inhibit the free passage between the two fans 6 and to hold in tension the same

The present invention is illustrated with reference to a preferred embodiment but is not limited to the said preferred embodiment, on the contrary the scope of rights in accordance with the present invention include all modification, corrections or the like provided that these are in the object of the present invention.

The present invention lends itself well to an industrial production in large scale

1. Fan-shaped pedestrian barrier characterized by the fact that it is made up of a metal sheet casing and two base brackets hinged at the ends to the metal casing, the housing-casing system contains two pneumatic actuators and two fans in PVC micro-perforated sheet; each pneumatic actuator and each fan in PVC micro-perforated sheet is connected at one end to the bottom of the metal casing and at the other end to the corresponding metallic casing cover, the operation of the pneumatic actuators determines the simultaneous rotation of the two metallic casing covers and thus the movement of the two fans in the PVC micro-perforated sheet.

2. Fan-shaped pedestrian barrier, according to claim 1, characterized in the fact that the metal casing comprises two symmetrical longitudinal sectors separated by a “U” sheet metal profile; the first sector of the metal casing contains the two base brackets of the pneumatic actuators, an electropneumatic valve for operating the actuators in the central position and two electromagnetic caches, in the second sector of the metal casing contains the two fans in the PVC micro-perforated sheet.

3. Fan-shaped pedestrian barrier, according to claim 2, characterized by the fact that the “U” sheet metal profile contains three pipes:
a. the compressed air piping connected to the electropneumatic valve serving the two actuators;
b. the electric pipeline connected to the electropneumatic valve; and
c. the electric pipeline connected to the two electromagnetic catches.

4. Fan-shaped pedestrian barrier, according to claim 3, characterized by the fact that the upstream and downstream of the “U” sheet metal profile, are positioned the serial connectors for the connection in series of fan-shaped barriers.

5. Fan-shaped pedestrian barrier, according to claim 3, characterized by the fact that the opening and closing of the compressed air circuit in the compressed air piping is determined by the drive of the electropneumatic valves through the opening and closing of the electric circuit.

6. Fan-shaped pedestrian barrier, as per claim 1, characterized by the fact that the two fans in the PVC micro-perforated sheet are connected together by elastic straps.

7. Method for the opening and closing of fan-shaped pedestrian barrier characterized in the following stages:
A. opening phase: the compressed air circuit closes and goes under pressure, the stems of the actuators extend, moving the metal casing cover and open up the fans in PVC micro-perforated sheet; the fans in PVC micro-perforated sheet in the open position are kept in tension by elastic straps which also have the function of inhibiting the free passage between the two fans;
B. closing phase: the compressed air circuit is opened, the stems of the actuators close again, moving the metal casing cover and close the fans in PVC micro-perforated sheet, the fans in PVC micro-perforated sheet in the closed position are housed in the respective areas of the metal housing; the electromagnetic catches are used to tighten the closure of the casing covers.

8. Fan-shaped pedestrian characterized by the fact it is retractable, fixed enclosed in the floor or in the case of temporary applications positioned and blocked on the floor by suitable means.
